(19) United States
(12) Patent Application Publication
(10) Pub. No.: US 2007/0153934 A1
(43) Pub. Date: Jul. 5, 2007

(54) Constant uneven power loading in beamforming systems for high throughput wireless communications

(75) Inventors: Jyh Chau Horng, Saratoga, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/321,267

(22) Filed: Dec. 29, 2005

(51) Int. Cl. H04L 1/02; H04L 27/00

(52) U.S. Cl. 375/267; 375/299

(57) ABSTRACT

An apparatus and method for closed-loop signaling over multiple channels in a telecommunication system, wherein a power loading method using constant uneven power loading under the power sum constraint is utilized. The detection of power loadings at the receiver is not necessary, which simplifies the receiver design. Nor is there a need for the transmitter to acknowledge the receiver, thereby reducing overhead.

### FIELD OF THE INVENTION

The present invention relates generally to data communication, and more particularly, to data communication in multi-channel communication system such as multiple-input multiple-output (MIMO) systems.

### BACKGROUND OF THE INVENTION

A multiple-input-multiple-output (MIMO) communication system employs multiple transmit antennas in a transmitter and multiple receive antennas in a receiver for data transmission. A MIMO channel formed by the transmit and receive antennas may be decomposed into independent channels, wherein each channel is a spatial sub-channel (or a transmission channel) of the MIMO channel and corresponds to a dimension. The MIMO system can provide improved performance (e.g., increased transmission capacity) if the additional dimensionalities created by the multiple transmit and receive antennas are utilized.

MIMO techniques are adopted in wireless standards, such as 3GPP, for high data rate services. In a wireless MIMO system, multiple antennas are used in both transmitter and receiver, wherein each transmit antenna can transmit a different data stream into the wireless channels whereby the overall transmission rate is increased.

There are two types of MIMO systems, known as open-loop and closed-loop. In an open-loop MIMO system, the MIMO transmitter has no prior knowledge of the channel condition (i.e., channel state information). As such, space-time coding techniques are usually implemented in the transmitter to prevent fading channels. In a closed-loop system, the channel state information (CSI) can be fed back to the transmitter from the receiver, wherein some pre-processing can be performed at the transmitter in order to separate the transmitted data streams at the receiver side. Such techniques are referred as beamforming techniques, which provide better performance in desired receiver's directions and suppress the transmit power in other directions.

The beamforming technique is widely recognized as a promising technique for high throughput wireless local-area network (WLAN) communications, especially for applications such as AV streaming services. In a beamforming system, the power loading for each data stream plays an important role in determining the system performance.

By using uneven power loadings, better performance can be achieved (e.g., S. A. Mujtaba, “TGn Sync Proposal Technical Specification”, a contribution to IEEE 802.11, 11-04-889r1, Nov. 2004). In general, the power loadings are changing with time, which is adapted to the time-varying channel conditions, to achieve maximal channel capacity. In order to demodulate the received signals correctly, the receiver needs information about the power loadings used at the transmitter. This can be achieved by either transmitting additional overhead information to indicate power loading values or performing power loading detection at the receiver side. One conventional method introduces overheads and thus the overall capacity is reduced. On the other hand, implementing power loading detection increases the receiver complexity and the detection errors will degrade the performance.

### BRIEF SUMMARY OF THE INVENTION

In one embodiment the present invention provides a power loading method using constant uneven power loading under the power sum constraint in a beamforming MIMO system including a transmitter and a receiver. For such a method, the detection of power loadings at the receiver is not necessary, which simplifies the receiver design. Nor is there a need for the transmitter to acknowledge the receiver, thereby reducing overhead.

In one implementation the present invention provides a telecommunication system, comprising a wireless transmitter that transmits data streams via multiple channels over a plurality of antennas, the transmitter including a power controller that selects fixed transmission power loading per channel that are time-invariant. The power loadings comprise fixed numbers that are based on the number of data streams. The system further comprises a receiver that receives the transmitted data streams and demodulates the received data streams based on power loading selection of the transmitter. The receiver determines the power loadings based on the number of data streams by detecting the number of data streams. The set of power loadings for two or more of spatial streams can be different values.

These and other features, aspects and advantages of the present invention will become understood with reference to the following description, appended claims and accompanying figures.

### BRIEF DESCRIPTION OF THE DRAWINGS

FIG. 1 shows a block diagram of an example MIMO SVD beamforming system with uneven power loadings;

FIG. 2 shows a block diagram of an example MIMO SVD beamforming system with constant uneven power loadings according to an embodiment of the present invention;

FIG. 3 shows an example PER performance vs. SNR for adaptive and fixed power loadings in channel E with MCS10;

FIG. 4 shows an example PER performance vs. SNR for adaptive and fixed power loadings in channel D with MCS10;

FIG. 5 shows an example PER performance vs. SNR for adaptive and fixed power loadings in channel B with MCS10;

FIG. 6 shows an example PER performance vs. SNR for adaptive and fixed power loadings in channel E with MCS14;

FIG. 7 shows an example PER performance vs. SNR for adaptive and fixed power loadings in channel D with MCS14; and

FIG. 8 shows an example PER performance vs. SNR for adaptive and fixed power loadings in channel B with MCS14.

### DETAILED DESCRIPTION OF THE INVENTION

In one embodiment the present invention provides a power loading method using constant uneven power loading under the power sum constraint in a beamforming MIMO system including a transmitter and a receiver. For such a method, the detection of power loadings at the receiver is not necessary, which simplifies the receiver design. Nor is there a need for the transmitter to acknowledge the receiver, thereby reducing overhead.

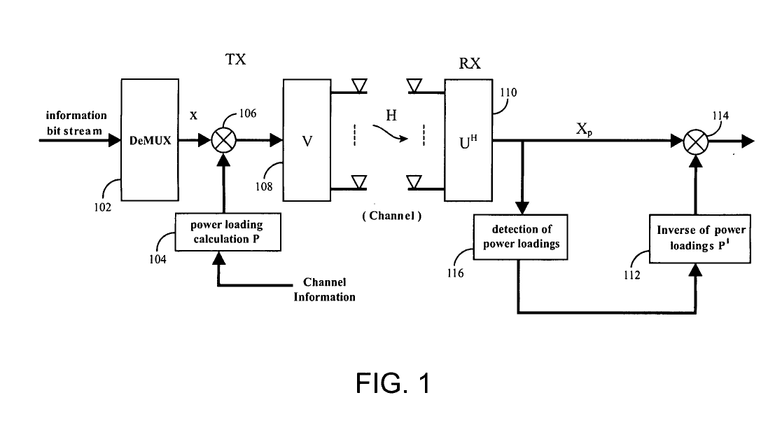

FIG. 1 shows an example block diagram of a MIMO system 100 including beamforming described in commonly assigned patent application Ser. No. 11/110,346 filed on Apr. 19, 2005 (incorporated herein by reference). The MIMO system 100 in FIG. 1 includes a transmitter TX comprising a demultiplexer DeMUX 102, a power loading unit 104 that implements power control for each transmitter antenna, a Combiner 106 and a V processing function 108. The demultiplexer DeMUX 102 splits the incoming information bits into Nₛₛ spatial streams. Each data stream is multiplied in the Combiner 106 by the respective power loading P is provided by the power loading unit 104. The MIMO system 100 further includes a receiver RX comprising a U^{H} processing function 110, a P⁻¹ (i.e., the inverse of P) function 112 and a combiner 114. The matrix p⁻¹ in function 112 is a Nₛₛ-by-Nₛₛ square matrix with inverse of the power loading P for each stream along the diagonal. The combiner 114 provides a multiplication operation.

In the MIMO system 100 of FIG. 1, the receiver RX is provided with the power loading information used by the transmitter TX, via the P⁻¹ function 112. Using the power loading information the receiver RX can properly demodulate the received signals. In one example, the transmitter TX provides the power loading information to the receiver RX. In another example, the receiver RX estimates the power loading of the transmitter TX.

The power loading unit 104 of the MIMO system 100 implements adaptive power loading for different transmit channels according to the present invention. In one embodiment, where the SNR thresholds for peak rate transmission are known, the power loading unit 104 performs channel power loading.

For the MIMO system 100 having a channel H with Nₜ transmit antennas and Nᵣ receiving antennas, the received signal y can be represented as:
y=HPx+n (1)

where x is the Nₛₛ×1 transmitted signal vector, P is a diagonal matrix with loading power αᵢ along the diagonal, and n is the additive noise in the channel.

The channel H comprises a Nᵣ×Nₜ matrix wherein each element hᵢⱼ of the matrix represents the channel response from j^{th} transmit antenna to i^{th} receiving antenna. By applying SVD to H, H can be expressed as:
H=U D V^{H} (2)

wherein U and V are unitary matrices (i.e., U is a Nᵣ×Nₛₛ matrix where Nₛₛ is the number of data stream, and V^{H} is a Nₛₛ×Nₜ matrix), and D is a Nₛₛ×Nₛₛ a diagonal matrix with the elements equal to the square-root of eigenvalues of the matrix (HH^{H}), where (·)^{H} is the Hermitian operation. In general, Nₜ>Nₛₛ.

As shown in FIG. 1, the information bit stream is first parsed into Nₛₛ streams by the DeMUX. Each stream is further multiplied by the power loading Pᵢ, which are the diagonal elements in the diagonal matrix P. The power scaled streams are then multiplied by the matrix V, which is the right singular matrix of the channel H, as shown in relation (2). The received signal y becomes:
y=HVPx+n (3)

At the receiver, by multiplying the received signal y by the matrix U^{H} (defined in relation (2) above), the received signal after processing Xₚ can be expressed as:
Xₚ=U^{H}y=DPx+U^{H}n (4)
whereby the transmitted data x can be completely separated after this operation since D and P are diagonal matrices.

By using uneven power loadings, better performance can be achieved. In general, the power loadings are changing with time, which is adapted to the time-varying channel conditions, to achieve maximal channel capacity. In order to demodulate the received signals correctly, the receiver has to know the power loadings used at the transmitter. This can be achieved by transmitting the power loading information to the receiver, or have the receiver itself detect the power loadings (e.g., FIG. 1, detector 116 and inverse power loading calculator 112).

The present invention provides an improved power loading method using constant uneven power loading under the power sum constraint in a beamforming MIMO system, wherein detection of power loadings at the receiver is not necessary, nor is there a need for the transmitter to acknowledge the receiver, thereby reducing overhead.

The wireless MIMO channels for WLAN environments are in general highly correlated with each other. The Doppler effects due to the mobility is much less compared with the cellular wireless systems, and thus it's relatively stationary. For beamforming systems supporting even transmission rates for all data streams, the policy for power loading calculation is inverse proportional to the eigenvalues of the channel covariance matrix. In general, the power loading is time-varying since the wireless channels are time-varying channels. However, investigation has shown that using fixed numbers for power loadings, the performance is almost the same as the time-varying cases if the fixed numbers are chosen to be the averaged power loading values over a time index. Thus, the set of numbers for power loadings depend only on the number of the data streams transmitted from the transmitter.

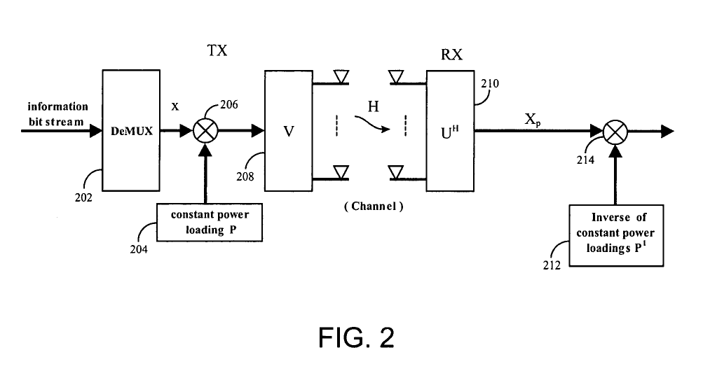

FIG. 2 shows a block diagram of an embodiment of a MIMO beamforming system 200 with constant uneven power loadings according to an embodiment of the present invention. The MIMO system 200 includes a transmitter TX comprising a demultiplexer DeMUX 202, a power loading unit 204 that implements power control for each transmitter antenna, a Combiner 206 and a V processing function 208. The demultiplexer DeMUX 202 splits the incoming information bits into Nₛₛ streams. Each data stream is multiplied in the Combiner 206 by the respective power loading P is provided by the power loading unit 204. The MIMO system 200 further includes a receiver RX comprising a U^{H} processing function 210, a p⁻¹ (i.e., the inverse of P) function 212 and a combiner 214. The matrix p⁻¹ in function 212 is a Nₛₛ-by-Nₛₛ square matrix with inverse of the power loading P for each stream along the diagonal. The combiner 214 provides a multiplication operation.

The power loading unit 204 provides fixed power loadings that are time-invariant, and are applied to the transmissions at the transmitter TX. The set of power loadings for a specific number of data streams is determined by averaging the power loading values of each stream across all channel realizations and channel models. Different number of data streams will have different set of constant but fixed power loading numbers. As such, the power loadings are available at the receiver RX if the receiver RX can detect the number of the data streams from the transmitter TX. Generally, the information on the number of data streams is transmitted through the signaling field (part of the overhead) before the data communications. Therefore, as shown in FIG. 2, the power loading detection at the receiver RX is not required for signal demodulation. Example steps of determining providing constant power in FIG. 2 include:

1. Determine the set of fixed power loading
a) For number of spatial streams Nss=2,
   Determine the fixed power loadings by averaging the power loading values of each stream across all channel realizations and channel models.
   Store the values in a table for Nss=2.
b) repeat (a) above for Nss=3,4, etc.

2. Use constant power loading table as:
a) Transmitter determines the number of spatial streams.
b) Transmitter signals the number of spatial streams in the PHY signaling field.
c) Transmitter uses the set of power loading values corresponding to the number of spatial streams used to adjust the power of each stream.
d) Transmitter sends data.
e) Receiver determines the number of spatial streams by parsing the PHY signaling field sent by transmitter.
f) Receiver uses the set of power loading values corresponding to the number of spatial streams used to perform the inverse power loading operation of each stream.
g) Receiver decodes data.

In the receiver RX, the p⁻¹ function 212 provides the power loading information such the receiver RX can properly demodulate the received signals. For a particular number of data/spatial streams, a set of constant but even power loading values are used. Each stream in this case will have different power loading adjustment.

It is noted that the total transmitted power is constraint to be a fixed number, i.e.,

$${\sum }_{i = 1}^{{N}_{ss}} {p}_{i}^{2} = {P}_{total} \qquad ( 5 )$$

Without loss of generosity, we may assume Pₜₒₜₐₗ=Nₛₛ. The present invention reduces complexity of conventional beamforming systems and further no detection errors are introduced. Further, additional transmission overhead for power loading indications to signal the receiver RX is not required, thereby reducing the overhead and increasing the system capacity.

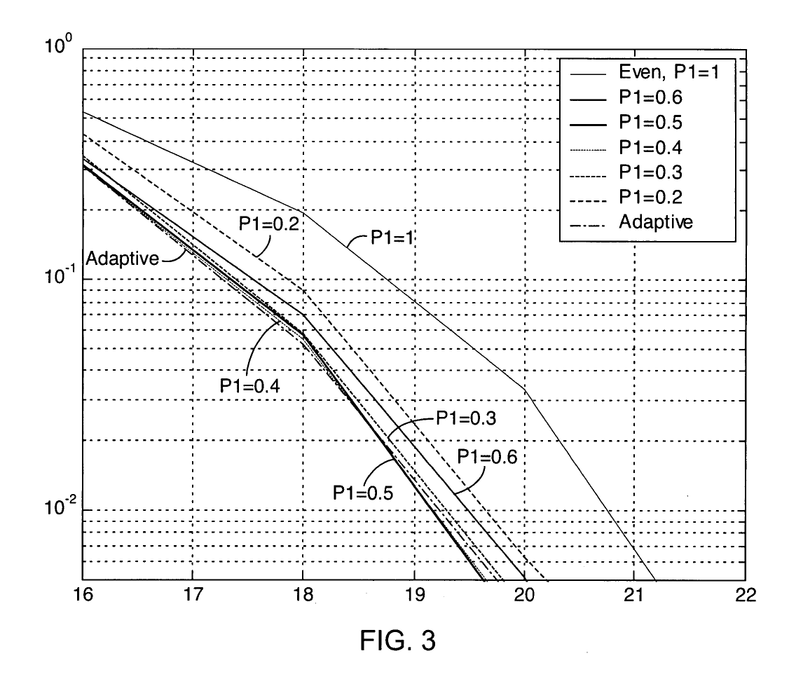

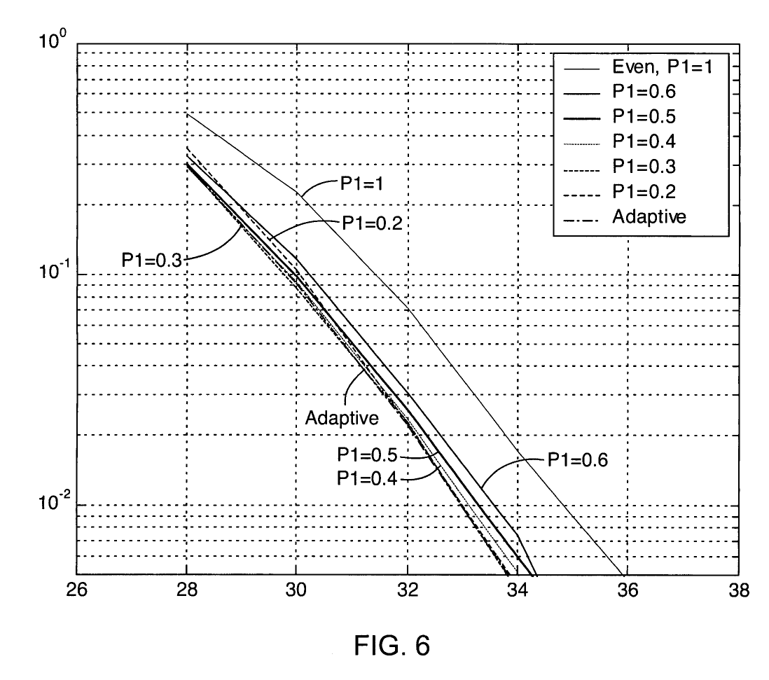

In order to illustrate the performance sensitivity to the constant numbers, several examples are shown in FIGS. 3-8. These examples compare PER (packet error rate) performances versus SNR (signal-to-noise ratio) for adaptive power loading case and fixed power loadings with various numbers under several WLAN MIMO channel models according to example embodiment of the present invention. The MIMO channel models are defined in “TGn channel models”, a contribution to IEEE 802.11, 11-03-940r2, Jan. 2004 (incorporated herein by reference), which simulates the real MIMO channels and provides a baseline channel models for fair comparisons. The simulated transmission rates are MCS10 (36 Mbps with QPSK and ¾ coding rate) under 2-by-2 channel models B, D, and E in FIGS. 3, 4 and 5 respectively. Further, The simulated transmission rates are MCS14 (108Mbps with 64QAM and ¾ coding rates) under 2-by-2 channel models B, D, and E in FIGS. 6, 7 and 8 respectively.

The averaged power loadings for 1^{st} stream and 2^{nd} stream are P₁² and P₂², respectively, which are tabulated in Table 1 below.

TABLE 1
Averaged values for adaptive power
loadings for channel B, D, and E.

| | Channel B | Channel D | Channel E |
|---|---|---|---|
| p₁² | 0.3632 | 0.4564 | 0.3848 |
| p₂² | 1.3368 | 1.5436 | 1.6152 |

The numbers are computed based on the 20000 channel realizations for channel models B, D, E. Results in Table 1 show the averaged values of p₁² in the range of [0.36, 0.45]. As shown in FIGS. 3-8, for the example constant power loadings according to the present invention there is only 0.2 dB performance degradation if p₁²=0.4 for all channels and transmission rates, compared with the adaptive power loading cases. The selection of the p₁²=0.4 is also consistent across different channel models.

Specifically, FIGS. 3-8 show PER vs SNR curve for different power loading values/methods. FIG. 3 shows an example PER performance vs. SNR for adaptive and fixed power loadings in channel E with MCS10. Referring to the legend in FIG. 3, the curve P₁=1 represents the PER for even power loadings between spatial stream 1 and spatial stream 2; the curve P₁=0.6 represents the PER for constant uneven power loading with power-loading value for stream 1 being 0.6 and power-loading value for stream 2 being 1.4; the curve P₁=0.5 represents the PER for constant uneven power loading with power-loading value for stream 1 being 0.5 and power-loading value for stream 2 being 1.5; the curve P₁=0.4 represents the PER for constant uneven power loading with power-loading value for stream 1 being 0.4 and power-loading value for stream 2 being 1.6; the curve P₁=0.3 represents the PER for constant uneven power loading with power-loading value for stream 1 being 0.3 and power-loading value for stream 2 being 1.7; the curve P₁=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

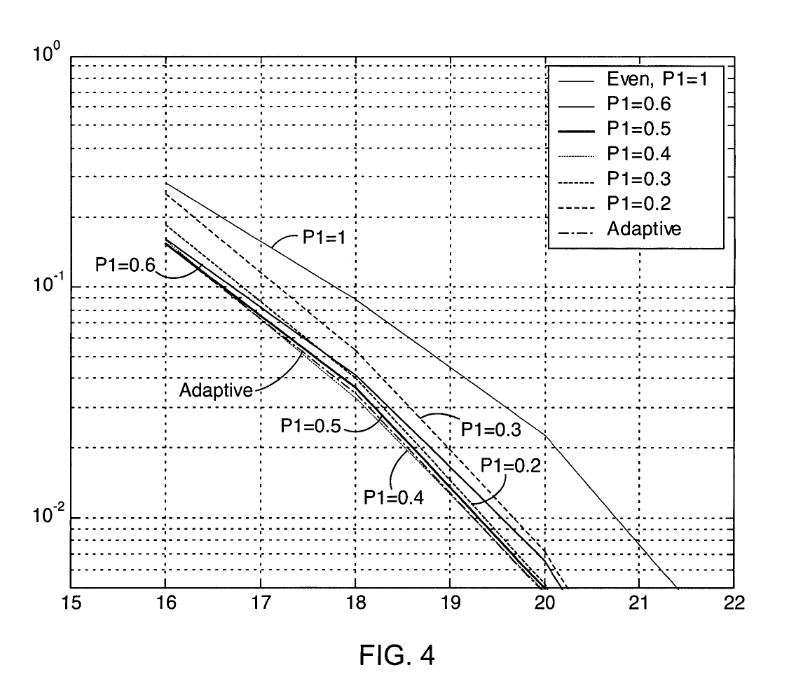

FIG. 4 shows an example PER performance vs. SNR for adaptive and fixed power loadings in channel D with MCS10. Referring to the legend in FIG. 4, the curve P₁=1 represents the PER for even power loadings between spatial stream 1 and spatial stream 2; the curve P₁=0.6 represents the PER for constant uneven power loading with power-loading value for stream 1 being 0.6 and power-loading value for stream 2 being 1.4; the curve P₁=0.5 represents the PER for constant uneven power loading with power-loading value for stream 1 being 0.5 and power-loading value for stream 2 being 1.5; the curve P₁=0.4 represents the PER for constant uneven power loading with power-loading value for stream 1 being 0.4 and power-loading value for stream 2 being 1.6; the curve P₁=0.3 represents the PER for constant uneven power loading with power-loading value for stream 1 being 0.3 and power-loading value for stream 2 being 1.7; the curve P₁=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

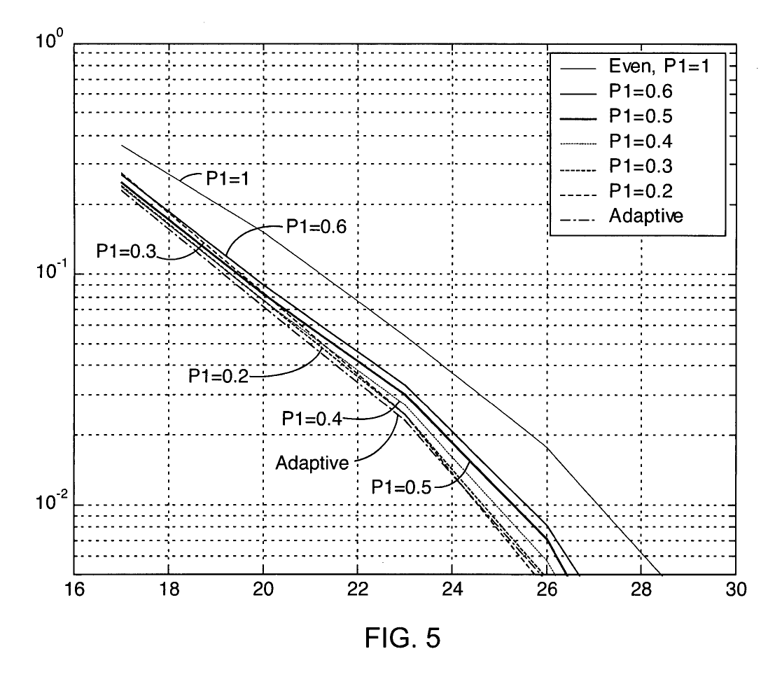

FIG. 5 shows an example PER performance vs. SNR for adaptive and fixed power loadings in channel B with MCS10. Referring to the legend in FIG. 5, the curve P1=1 represents the PER for even power loadings between spatial stream 1 and spatial stream 2; the curve P1=0.6 represents the PER for constant uneven power loading with power-loading value for stream 1 being 0.6 and power-loading value for stream 2 being 1.4; the curve P1=0.5 represents the PER for constant uneven power loading with power-loading value for stream 1 being 0.5 and power-loading value for stream 2 being 1.5; the curve P132 0.4 represents the PER for constant uneven power loading with power-loading value for stream 1 being 0.4 and power-loading value for stream 2 being 1.6; the curve P1=0.3 represents the PER for constant uneven power loading with power-loading value for stream 1 being 0.3 and power-loading value for stream 2 being 1.7; the curve P1=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

FIG. 6 shows an example PER performance vs. SNR for adaptive and fixed power loadings in channel E with MCS14. Referring to the legend in FIG. 6, the curve P1=1 represents the PER for even power loadings between spatial stream 1 and spatial stream 2; the curve P1=0.6 represents the PER for constant uneven power loading with power-loading value for stream 1 being 0.6 and power-loading value for stream 2 being 1.4; the curve P1=0.5 represents the PER for constant uneven power loading with power-loading value for stream 1 being 0.5 and power-loading value for stream 2 being 1.5; the curve P1=0.4 represents the PER for constant uneven power loading with power-loading value for stream 1 being 0.4 and power-loading value for stream 2 being 1.6; the curve P1=0.3 represents the PER for constant uneven power loading with power-loading value for stream 1 being 0.3 and power-loading value for stream 2 being 1.7; the curve P1=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

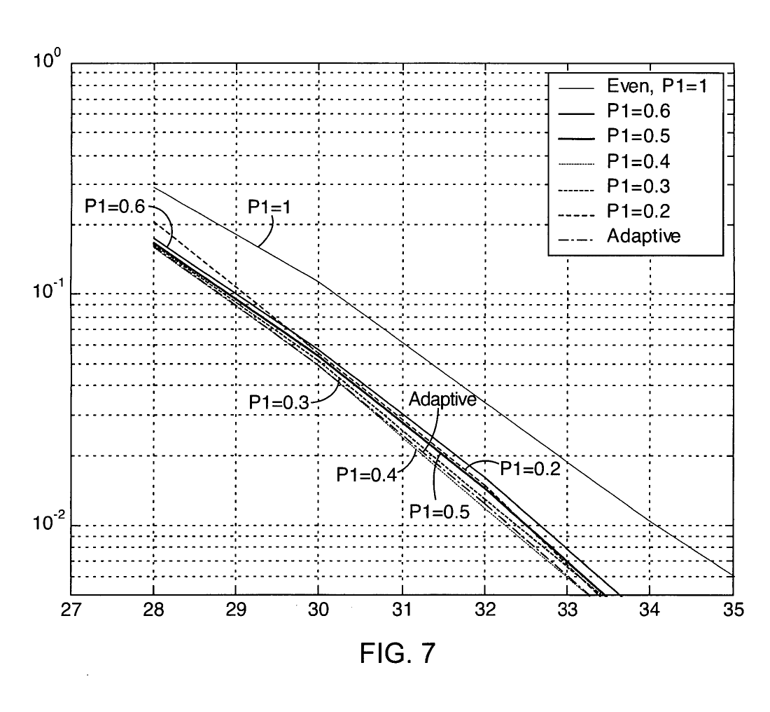

FIG. 7 shows an example PER performance vs. SNR for adaptive and fixed power loadings in channel D with MCS14. Referring to the legend in FIG. 7, the curve P1=1 represents the PER for even power loadings between spatial stream 1 and spatial stream 2; the curve P1=0.6 represents the PER for constant uneven power loading with power-loading value for stream 1 being 0.6 and power-loading value for stream 2 being 1.4; the curve P1=0.5 represents the PER for constant uneven power loading with power-loading value for stream 1 being 0.5 and power-loading value for stream 2 being 1.5; the curve P1=0.4 represents the PER for constant uneven power loading with power-loading value for stream 1 being 0.4 and power-loading value for stream 2 being 1.6; the curve P1=0.3 represents the PER for constant uneven power loading with power-loading value for stream 1 being 0.3 and power-loading value for stream 2 being 1.7; the curve P1=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

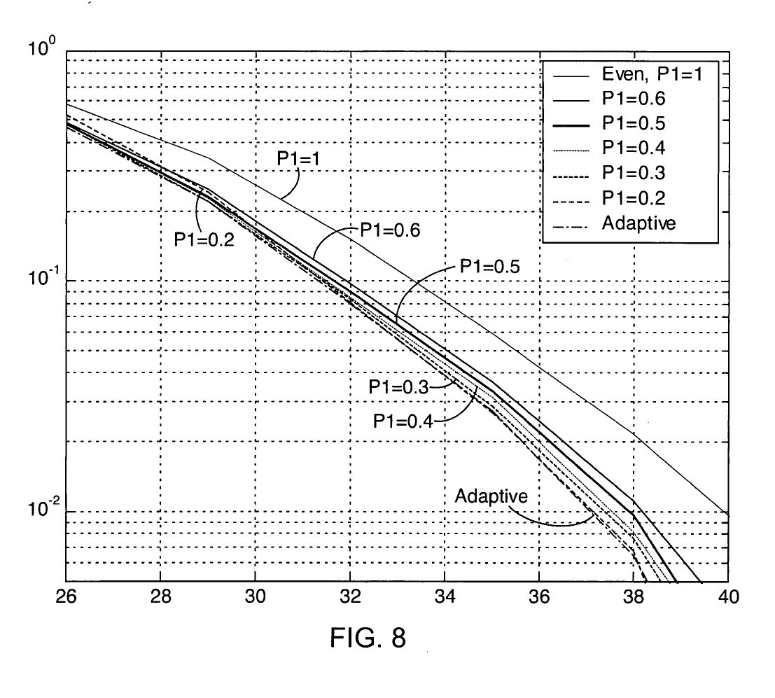

FIG. 8 shows an example PER performance vs. SNR for adaptive and fixed power loadings in channel B with MCS14. Referring to the legend in FIG. 8, the curve P1=1 represents the PER for even power loadings between spatial stream 1 and spatial stream 2; the curve P1=0.6 represents the PER for constant uneven power loading with power-loading value for stream 1 being 0.6 and power-loading value for stream 2 being 1.4; the curve P1=0.5 represents the PER for constant uneven power loading with power-loading value for stream 1 being 0.5 and power-loading value for stream 2 being 1.5; the curve P1=0.4 represents the PER for constant uneven power loading with power-loading value for stream 1 being 0.4 and power-loading value for stream 2 being 1.6; the curve P1=0.3 represents the PER for constant uneven power loading with power-loading value for stream 1 being 0.3 and power-loading value for stream 2 being 1.7; the curve P1=0.2 represents the PER for constant uneven power loading with power-loading value for stream 1 being 0.2 and power-loading value for stream 2 being 1.8; and the curve Adaptive represents the PER with adaptive power loading (i.e., power loading values of two streams changes according to the channels).

As such, the present invention reduces the overhead of signaling power loading values to the receiver, thereby increasing the system capacity. Further, according to the present invention, power loading detection at the receiver is not required, which simplifies the receiver complexity. Simulation results show that, by using the present invention, similar performance can be achieved as in the adaptive power loading cases under WLAN channel environments.

The present invention has been described in considerable detail with reference to certain preferred versions thereof; however, other versions are possible. Therefore, the spirit and scope of the appended claims should not be limited to the description of the preferred versions contained herein.

What is claimed is:

1. A telecommunication system, comprising:
a wireless transmitter that transmits data streams via multiple channels over a plurality of antennas, the transmitter including a power controller that selects fixed transmission power loading per channel that are time-invariant.

2. The system of claim 1 wherein the transmitter is a MIMO transmitter.

3. The system of claim 1 wherein the power loadings comprise fixed numbers that are based on the number of data streams.

4. The system of claim 1 further comprising a receiver that receives the transmitted data streams and demodulates the received data streams based on power loading selection of the transmitter.

5. The system of claim 4 wherein the receiver determines the power loadings based on the number of data streams.

6. The system of claim 5 wherein the receiver detects the number of data streams.

7. The system of claim 6 wherein the telecommunication system comprises a close-loop MIMO system.

8. The system of claim 6 wherein the power loadings for two or more of spatial streams have different set of values.

9. A closed-loop signaling method over multiple channels in a telecommunication system, comprising the steps of:
obtaining an information bit stream;
selecting the number transmission streams;
determining transmission power loading per transmission stream as a fixed transmission power loading that is time-invariant; and
transmitting the information bit stream via said multiple channels over a plurality of transmitter antennas according to the power loading per stream.

10. The method of claim 9 wherein the telecommunication system comprises a MIMO transmission system.

11. The method of claim 9 wherein the power loadings comprise fixed numbers that are based on the number of data streams.

12. The method of claim 9 further comprising the steps of receiving the transmitted data streams and demodulating the received data streams based on power loading selection of the transmitter.

13. The method of claim 12 wherein the receiving step further includes the steps of determining the power loadings based on the number of data streams.

14. The method of claim 13 wherein the receiving steps further includes the steps of detecting the number of data streams.

15. The method of claim 14 wherein the telecommunication system comprises a close-loop MIMO system.

16. The method of claim 14 wherein the wireless transmitter comprises an orthogonal frequency division multiplexing (OFDM) transmitter.

17. The method of claim 8 wherein the power loadings for two or more of spatial streams have different set of values.
